(19) United States
(12) Patent Application Publication
(10) Pub. No.: US 2008/0243510 A1
(43) Pub. Date: Oct. 2, 2008

(54) OVERLAPPING SCREEN READING OF NON-SEQUENTIAL TEXT

(76) Inventor: Lawrence C. Smith, Charlevoix, MI (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(21) Appl. No.: 11/692,253

(22) Filed: Mar. 28, 2007

(51) Int. Cl. G10L 13/00

(52) U.S. Cl. 704/259

(57) ABSTRACT

Embodiments of the present invention address deficiencies of the art in respect to screen reading non-sequential text and provide a method, system and computer program product for overlapping screen reading of non-sequential text, such as a tag cloud or Web page header. In an embodiment of the invention, an overlapping screen reading method for a non-sequential list of words can include computing different speech synthesis parameters for different words in a non-sequential list of words, generating different audio forms for each of the different words according to the different speech synthesis parameters, and overlappingly merging the generated different audio forms into a single audio stream. The speech synthesis parameters can include, for instance, separation, volume, tone and location speech synthesis parameters. Thereafter, the method can include playing back the single audio stream to simulate a natural visual scanning of the non-sequential list of words.

### BACKGROUND OF THE INVENTION

1. Field of the Invention

The present invention relates to the field of text screen reading and more particularly to screen reading of non-sequential text

2. Description of the Related Art

For more than ten years, computer scientists and engineers have addressed the accessibility of the computer program user interface—particularly for the benefit of those end users unable to interact with a computer program utilizing conventional means such as a mouse or keyboard. Presently, several assistive technologies have been widely distributed, usually in concert with the distribution of an operating system, to provide one or more alternative user interface mechanisms for the purpose of enhanced accessibility. Examples of assistive technologies include an audio user interface such as a screen reader otherwise referred to a “text reader”.

Text readers also know as screen readers generally “read aloud” what is presented on a computer screen. Consequently, a text reader can be critical for individuals with learning disabilities since the operation of the text reader allows students to hear words on the screen. Text readers become invaluable when used in conjunction with other technologies such as word prediction, word processing, and spell checking. While text readers originally had been designed for the visually impaired, more sophisticated and affordable text readers have been marketed to a larger population, including users with or without learning disabilities. One new and important market for text readers includes the personal applications market which can encompass personal productivity applications and collaborative applications, such as electronic mail clients and instant messengers, and more recently, Web 2.0.

Web 2.0 has been commonly defined as the World Wide Web as a platform. One favorable aspect of Web 2.0 includes tagging. Tagging is a participation method by which users can enrich information in Web 2.0 places. Tags, and their mass visual representation, “tag lists” or “tag clouds”, in turn, provide organizational tools for information in Web 2.0 places. In this regard, a tag cloud is a grouping of tags associated with content, from a single source or multiple sources. Tag clouds are a visual tool and tags that are used more often generally are shown with bigger and darker fonts whereas less frequently used tags are shown with a smaller and lighter colored font. In this way, a glancing inspection of a tag cloud in lieu of a comprehensive reading of each tag in the tag cloud can provide a good indication for the end user of the prominent tags.

Notably, the technical challenge of screen reading conventional sequences of text, such as in an ordinary document, long has been conquered. In particular, advanced screen readers apply pauses and tone changes and syllabic emphasis where grammatically called for in the sequence of text. Non-sequential text, such as that found in a tag cloud, however, provides a completely different challenge. Within a tag cloud, no grammar relates to the ordering of tags and the reading of the tags. A cursory inspection of a tag cloud provides little guidance on how to read back the content with a screen reader. Accordingly, the advantage of tag cloud enjoyed by the sighted and visual end user escapes the non-sighted and audibly inclined end user.

### BRIEF SUMMARY OF THE INVENTION

Embodiments of the present invention address deficiencies of the art in respect to screen reading non-sequential text and provide a novel and non-obvious method, system and computer program product for overlapping screen reading of non-sequential text, such as a tag cloud or Web page header. In an embodiment of the invention, an overlapping screen reading method for a non-sequential list of words can include computing different speech synthesis parameters for different words in a non-sequential list of words, generating different audio forms for each of the different words according to the different speech synthesis parameters, and overlappingly merging the generated different audio forms into a single audio stream. The speech synthesis parameters can include, for instance, separation, volume, tone and location speech synthesis parameters. Thereafter, the method can include playing back the single audio stream to simulate a natural visual scanning of the non-sequential list of words.

In one aspect of the embodiment, the method can include re-computing different speech synthesis parameters for different words in a non-sequential list of words, generating additionally different audio forms for each of the different words according to the different speech synthesis parameters, overlappingly merging the generated additionally different audio forms into a different single audio stream, and playing back the different single audio stream to simulate a natural visual re-scanning of the non-sequential list of words. In another aspect of the embodiment, the method can include overlappingly merging the generated different audio forms in a different ordering into a different single audio stream, and playing back the different single audio stream to simulate a natural visual re-scanning of the non-sequential list of words.

In another embodiment of the invention, a screen reading data processing system can be provided. The system can include a screen reader coupled to a speech synthesizing text-to-speech (TTS) engine. The system further can include overlapping non-sequential text screen reading logic. The logic can include program code enabled to compute different speech synthesis parameters for the TTS engine for different words in a non-sequential list of words, to generate through the TTS engine different audio forms for each of the different words according to the different speech synthesis parameters, to overlappingly merge the generated different audio forms into a single audio stream, and to provide the single audio stream to the screen reader for playback in order to simulate a natural visual scanning of the non-sequential list of words.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a screen reading data processing system configured for overlapping screen reading of non-sequential text; and,

FIG. 2 is a flow chart illustrating a process for overlapping screen reading of non-sequential text.

### DETAILED DESCRIPTION OF THE INVENTION

Embodiments of the present invention provide a method, system and computer program product for overlapping screen reading of non-sequential text. In accordance with an embodiment of the present invention, words in non-sequential text such as an index to Web content or a tag cloud can be parsed and the audio form of the words in the non-sequential text can be individually configured for corresponding visual characteristics of the words in the non-sequential text. Thereafter, the individually configured audio form of each of the words can be overlappingly merged to form an audio stream played back over an audio channel. The process can repeat for variant audio forms for the words in the non-sequential text so as to provide different audio perspectives of the non-sequential text. In this way, the audio experience of interacting with non-sequential text can reflect a similar visual experience of interacting with non-sequential text.

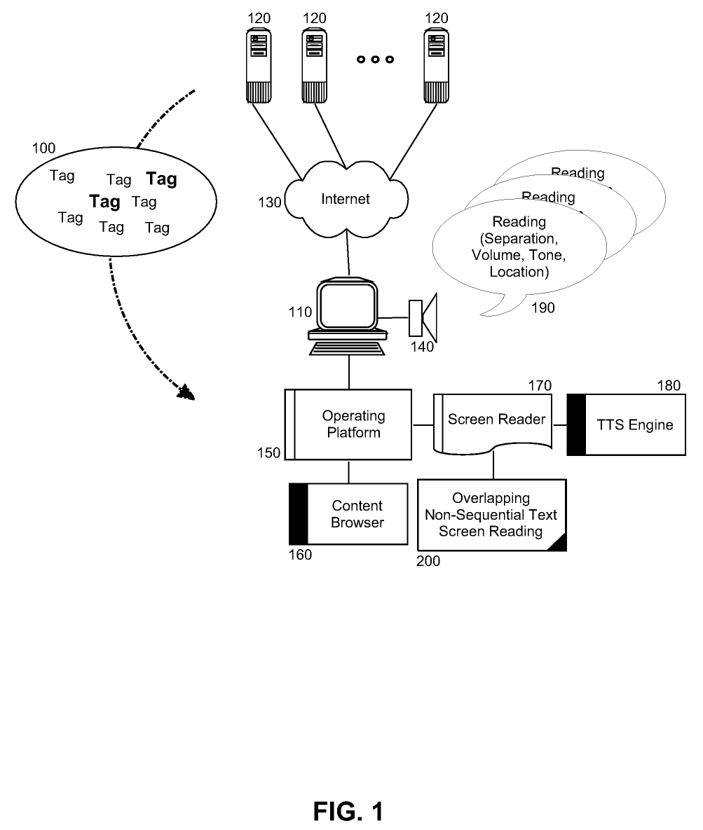

In further illustration, FIG. 1 is a schematic illustration of a screen reading data processing system configured for overlapping screen reading of non-sequential text. The system can include a host computing device 110 configured for coupling to one or more content sources 120 over a computer communications network 130 such as the global Internet. The content sources 120 can include Web 2.0 sources include content incorporating an index or a tag cloud. To enable interactions with content provide by the content sources 120, the host computing device 110 can include an operating platform 150 supporting the operation of a content browser 160. Notably, a screen reader 170 coupled to a TTS engine 180 can be provided such that content presented within the content browser 160 can be audibly presented to an end user through audio transducer 140.

Overlapping non-sequential text screen reading logic 200 can be coupled to the screen reader 170. The overlapping non-sequential text screen reading logic 200 can include program code enabled to control the screen reader 170 and the TTS engine 180 in order to provide multiple different overlapping presentations 190 of different audio forms through the audio transducer 140 for words in non-sequential text 100, for example tags in a tag cloud, or index entries in a Web page. In this way, an audibly sensitive end user can audibly scan the content of the non-sequential text 100 much in the same way the visually sensitive end user would visually scan the visual presentation of the non-sequential text—by looking for variances among the words in appearance in the aggregate through multiple glances at the aggregation of the words in non-sequential text.

In operation, words in non-sequential text 100 can be parsed by the screen reader 170 and the program code of the overlapping non-sequential text screen reading logic 200 can be enabled to determine an audio form for each of the words corresponding to the visual presentation of the words in the non-sequential text 100. Exemplary audio parameters include separation, volume, tone and location. Thereafter, the different audio forms can be overlappingly merged such that the end portions of the different audio forms overlap one another within an audio stream 190 of overlappingly merged audio forms to provide an overlapping read back of the words in the non-sequential text 100. The process can repeat with differing audio forms for the words so as to provide a repeated playback of differing audio streams 190 for the non-sequential text 100

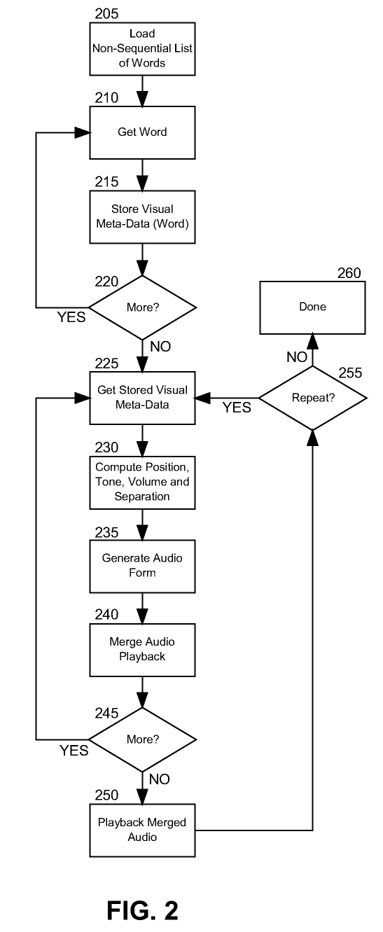

In further illustration, FIG. 2 is a flow chart illustrating a process for overlapping screen reading of non-sequential text. Beginning in block 205, a non-sequential list of words can be loaded for processing, for example a tag cloud or a menu header for a Web site. In block 210, a word can be retrieved from the non-sequential list of words, though it is to be recognized that as no particular sequence of words may exist in the non-sequential list of words, the retrieved word cannot be termed the “first” word in the non-sequential list of words—only the first retrieved word. Thereafter, in block 215 the visual meta-data for the word can be stored, including a position within the non-sequential list of words, a proximity to other words in the non-sequential list of words, a separation between proximate words in the non-sequential list of words, and a visual appearance of the word in the sequential list of words.

In decision block 220, when no additional words remain to be processed in the non-sequential list of words, in block 225 the stored visual meta-data for a word in the non-sequential list of words can be retrieved and in block 230, position, tone, volume and separation speech synthesis parameters can be computed for the word. Subsequently, in block 235 an audio form can be synthesized for the word and the audio form can be overlapping merged with other audio forms into an audio stream for the non-sequential list of words. In decision block 245, the process can repeat for the remaining words in the non-sequential list of words. When no words remain in the non-sequential list of words, in block 250, the audio stream can be played back.

Notably, in decision block 255, the process can repeat for a different ordering of the words in the non-sequential list of words to produce a different audio stream. As well, the process can repeat for different computed speech synthesis parameters for the words in the non-sequential list to produce a different audio stream. The assembly and presentation of the different audio streams can assist the audibly sensitive end user in audibly scanning the non-sequential list of words much in the same way a sighted individual visually scans a non-sequential list of words. Thus, non-sequential list of words such as tag clouds and Web site headers can be screen read for natural comprehension by the non-sighted and partially sighted as well as those preferring an audio user interface.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. An overlapping screen reading method for a non-sequential list of words, the method comprising:
computing different speech synthesis parameters for different words in a non-sequential list of words;
generating different audio forms for each of the different words according to the different speech synthesis parameters;
overlappingly merging the generated different audio forms into a single audio stream; and,
playing back the single audio stream to simulate a natural visual scanning of the non-sequential list of words.

2. The method of claim 1, further comprising:
re-computing different speech synthesis parameters for different words in a non-sequential list of words;
generating additionally different audio forms for each of the different words according to the different speech synthesis parameters;
overlappingly merging the generated additionally different audio forms into a different single audio stream; and,
playing back the different single audio stream to simulate a natural visual re-scanning of the non-sequential list of words.

3. The method of claim 1, further comprising:
overlappingly merging the generated different audio forms in a different ordering into a different single audio stream; and,
playing back the different single audio stream to simulate a natural visual re-scanning of the non-sequential list of words.

4. The method of claim 1, wherein computing different speech synthesis parameters for different words in a non-sequential list of words, comprises computing different separation, volume, tone and location speech synthesis parameters for different words in a non-sequential list of words.

5. The method of claim 1, wherein computing different speech synthesis parameters for different words in a non-sequential list of words, comprises computing different speech synthesis parameters for different tags in a tag cloud.

6. The method of claim 1, wherein computing different speech synthesis parameters for different words in a non-sequential list of words, comprises computing different speech synthesis parameters for different index entries in a Web site header.

7. A screen reading data processing system comprising:
a screen reader coupled to a speech synthesizing text-to-speech (TTS) engine; and,
overlapping non-sequential text screen reading logic comprising program code enabled to compute different speech synthesis parameters for the TTS engine for different words in a non-sequential list of words, to generate through the TTS engine different audio forms for each of the different words according to the different speech synthesis parameters, to overlappingly merge the generated different audio forms into a single audio stream, and to provide the single audio stream to the screen reader for playback in order to simulate a natural visual scanning of the non-sequential list of words.

8. The system of claim 7, wherein the non-sequential list of words comprises a tag cloud.

9. The system of claim 7, wherein the non-sequential list of words comprises a Web page header.

10. The system of claim 7, wherein the speech synthesis parameters comprise separation, volume, tone and location speech synthesis parameters.

11. A computer program product comprising a computer usable medium embodying computer usable program code for overlapping screen reading for a non-sequential list of words, the computer program product comprising:
computer usable program code for computing different speech synthesis parameters for different words in a non-sequential list of words;
computer usable program code for generating different audio forms for each of the different words according to the different speech synthesis parameters;
computer usable program code for overlappingly merging the generated different audio forms into a single audio stream; and,
computer usable program code for playing back the single audio stream to simulate a natural visual scanning of the non-sequential list of words.

12. The computer program product of claim 11, further comprising:
computer usable program code for re-computing different speech synthesis parameters for different words in a non-sequential list of words;
computer usable program code for generating additionally different audio forms for each of the different words according to the different speech synthesis parameters;
computer usable program code for overlappingly merging the generated additionally different audio forms into a different single audio stream; and,
computer usable program code for playing back the different single audio stream to simulate a natural visual re-scanning of the non-sequential list of words.

13. The computer program product of claim 11, further comprising:
computer usable program code for overlappingly merging the generated different audio forms in a different ordering into a different single audio stream; and,
computer usable program code for playing back the different single audio stream to simulate a natural visual re-scanning of the non-sequential list of words.

14. The computer program product of claim 11, wherein the computer usable program code for computing different speech synthesis parameters for different words in a non-sequential list of words, comprises computer usable program code for computing different separation, volume, tone and location speech synthesis parameters for different words in a non-sequential list of words.

15. The computer program product of claim 1, wherein the computer usable program code for computing different speech synthesis parameters for different words in a non-sequential list of words, comprises computer usable program code for computing different speech synthesis parameters for different tags in a tag cloud.

16. The computer program product of claim 1, wherein the computer usable program code for computing different speech synthesis parameters for different words in a non-sequential list of words, comprises computer usable program code for computing different speech synthesis parameters for different index entries in a Web site header.
